(19) United States
(12) Patent Application Publication
(10) Pub. No.: US 2009/0259362 A1
(43) Pub. Date: Oct. 15, 2009

(54) METHOD FOR GENERATING SUBSTITUTE VALUES FOR MEASURED VALUES IN A CONTROL UNIT

(75) Inventor: Stefan Veittinger, Langenargen (DE)

Correspondence Address: DAVIS & BUJOLD, P.L.L.C., 112 PLEASANT STREET, CONCORD, NH, 03301, US

(73) Assignee: ZF Friedrichshafen AG, Friedrichshafen (DE)

(21) Appl. No.: 12/421,085

(22) Filed: Apr. 9, 2009

(30) Foreign Application Priority Data
Apr. 14, 2008 (DE) 10 2008 001 143.6

(51) Int. Cl. G06F 7/00; G06F 19/00

(52) U.S. Cl. 701/35; 702/116

(57) ABSTRACT

A method of generating substitute values for measured values in a control unit by correlating at least two measured values. The method includes first saving at least one value which predefines a relationship between the two measured values. The measured values are measured, during the operation of the control unit, and the predefined relationship value is overwritten in the memory unit by the relationship actually arising during operation on the basis of the measurement. Upon recognition of an error or a failure of the measuring apparatus, which is associated with the measured values, with the aid of the relationship actually arising during operation on the basis of the measurement, a substitute value for the measured values, which were to be measured by the defective measuring apparatus, is then calculated and transmitted to the control unit for further processing.

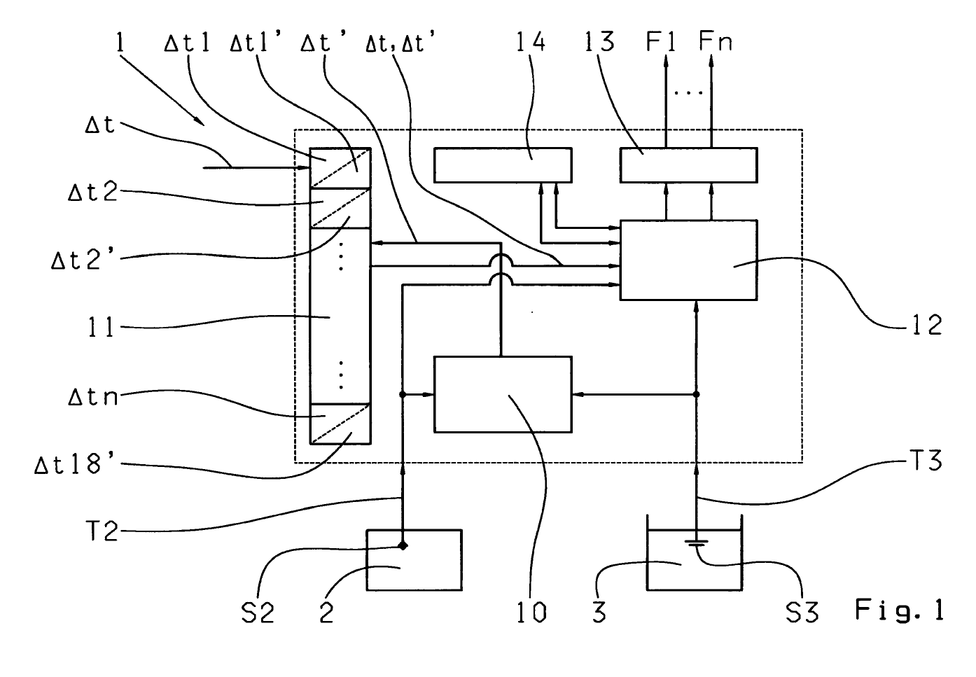

This application claims priority from German patent application serial no. 10 2008 001 143.6 filed Apr. 14, 2008.

### FIELD OF THE INVENTION

The invention relates to a method for generating substitute values for measured values in a control unit or regulatory unit, whereby at least two measured values are brought into relation with each other.

### BACKGROUND OF THE INVENTION

The use of substitute values is known in measurement and control engineering to keep the failure tolerance of measurement and control systems as high as possible. Here a system is designated as “failure tolerant” if it recognizes in a timely manner the failure of internal components which can lead to the failures of certain necessary output information, and through suitable countermeasures prevents the overall output value falling short of a required accuracy or from not being capable of being formed at all.

A cooling system of a water-cooled motor vehicle internal combustion motor is described in the closest German patent DE 36 38 131 A1 in which the greatest possible protection for the internal combustion motor is to be attained in the event of the failure of one or all thermostats involved (specifically two thermostats or heat sensors are provided). For this purpose, in the event of a failure of a thermostat, the cooling system has an electronic control unit which assumes the function of a thermostat such that a temperature substitute value is formed which largely corresponds to the actual temperature at the location of the thermostat which failed. This temperature substitute value is determined in the manner that the temperature difference between the temperatures determined by the two thermostats, experimentally measured, saved and stored under normal conditions, is deducted from or added to this temperature which is determined by the thermostat that did not fail. It is moreover proposed that the temperature difference experimentally ascertained during normal operation and saved in the control unit be additionally modified as a function of the motor rotational speed and/or driving speed to be able to arrive at a more exact regulation with values dependent upon the rotational and or travel speed.

A method for determining a braking pressure is described in German patent DE 10 2006 033 351 A1, where a pressure substitute value can be generated by computer on the basis of other information (for example, sensor information) available to the system control or regulation unit in the event of a failure of a pressure sensor. For example, certain measured values, such as motor vehicle oag and the longitudinal gradient of the travel path, are brought into relation with each other for calculating the substitute value.

German patent DE 101 35 586 B4 describes a reconfiguration method for a sensor system to compensate for failures in the sensor system. Moreover at least two monitors are provided (each monitor consists respectively of at least one sensor for measuring system conditions and at least one system model for estimating system conditions of an application system), whereby in the event of the recognition of the defective character or the (temporary) failure of a monitor, a further monitor is activated as a substitute. Threshold values are defined for evaluation of the selection status which in each case represent the deviation between the measured value and the system state estimated by the systemic model, whereby a first threshold value indicates a possible failure of a monitor and a second threshold value confirms the failure of the monitor.

### SUMMARY OF THE INVENTION

The object of the present invention is to present a representative method in which the calculation of the substitute values to be adduced in the event of an error can be adapted to the real situation as optimally as possible, where the expenditure of control to be engaged is to be kept as low as possible.

The invention accordingly proceeds from a method for generating substitute values for measured values in a control or regulatory unit, whereby at least two measured values are brought into relation with each other. It is provided in accordance with the invention that first at least one value is saved in a memory unit of a control device which predefines a certain relationship between the at least two measured values, that during operation of the control unit the measured values are measured and the predefined relationship is overwritten by the relationship arising on the basis of the measurement during actual operation, and that, after recognizing an error or a failure of a measuring device associated with a measured value with the aid of the relationship actually arising during operation on the basis of the measurement, a substitute value is calculated for the value to be measured by the defective or the defunct measuring device and is made available to the control unit for further processing.

A very good adaptation to the real situation is possible by this method, since the relationship between the measured values (preferably after a corresponding debouncing time and with suitable, for example, sliding average value generation, in order largely to rule out fluctuations and inaccuracies) is being constantly tracked or adapted during actual operation. Consequently, substitute values, which are based upon realistic measured values corresponding to the respectively applied system can be calculated at any time.

It is thereby advantageous if the at least two measured values are of the same kind, namely indicating the same physical value, and the predefined relationship or the relationship between the at least two measured values is formed by an estimated or actually measured differential amount of the values of at least two measured values. This simplifies the measuring and also the calculation complexity for generating substitute values and consequently leads to a more rapid mode of operation of the control unit.

The method of the invention can be realized in an especially simple manner, if appropriately at least two measured values are temperatures. One measure value can, for example, be the temperature of motor oil in a motor of the motor vehicle and the other measured value can, for example, be the temperature of a motor control unit which is exposed to the development of heat of the motor. Likewise, the transmission oil temperature and the temperature of a transmission control unit can also be used, whereby the transmission control unit is exposed to the development of heat of the transmission.

It is moreover provided in an extremely advantageous further development of the conception of the invention that several values can be saved or stored in the memory of the control or regulatory unit for estimated or measured relationships between the at least two measured values. Thus real values that are related across an entire measured region previously established can be saved.

Obviously it cannot be ruled out that, in an unfavorable case, all measuring devices or sensors involved fail. For this case, an emergency program is appropriately provided such that, after recognizing the errors of all measuring devices associated at least with two measured values, the values placed in another memory unit of the control unit prior to this error recognition are used. These are, depending on the time of such a failure, either the values programmed in or those already based on the factual measurements of the concrete system.

### BRIEF DESCRIPTION OF THE DRAWING

The method of the invention will be explained in greater detail below on the basis of a preferred embodiment and a drawing. Here the sole FIGURE shows a considerably simplified block diagram of a control unit which operates according to the method of the invention.

### DETAILED DESCRIPTION OF THE PREFERRED EMBODIMENTS

The control unit 1 can, by way of example, serve to actuate a coolant circulation system of a motor vehicle. The control unit 1 has a subtraction unit 10, a first memory unit 11, a logic central processor 12, as well as a logic evaluation unit 13. Temperatures of a motor control apparatus (ECU=Engine Control Unit) 2 or of motor oil 3 are recorded by way of temperature sensors S2 or S3 during the operation of the control unit 1 and forwarded to the control unit 1 in the form of temperature signals T2 or T3.

The memory unit 11, which is preferably a non-volatile electronic memory component (EEPROM), is programmed or loaded prior to the control unit 1 being placed into operation with predefined temperature difference values Δt1 to Δtn that is illustrated by the arrow Δt which is placed into the memory unit 11 from outside. The number of difference values Δt1 to Δtn can moreover vary as a function of the temperature class to be established and the temperature range. A range from −30° C. to +150° C. with temperature classes in a width of 10 Kelvin (10° c) is established as a measuring range for the present operational example. As a result, 18 temperature classes arise in this case, namely temperature difference values Δt1 to Δt18, whereby a value of 30 Kelvin (30° C.) is selected as the “default” difference value (predefined value) between the temperature signals T2 and T3 across all temperature classes, and all temperature difference values Δt1 to Δt18 are next set at 30 Kelvin (30° C.) in the memory unit 11.

Upon activation of the control unit 1 the temperature signals T2, T3, generated by the temperature sensors S2, S3 in the corresponding measuring cycle, are fed to the subtraction unit 10 and the calculated difference value (according to the temperature class present during operation or just reached) is saved in the memory unit 11 as the temperature difference value Δ′. The over-writing of the predefined temperature difference values Δt by the values Δt′ actually measured in real operation (value tracking, see arrow Δt′ to the memory unit 11) preferably first takes place after a debouncing or build up time to be established, whereby a sliding mean value formation is advantageous. At the same time, the temperature signal values T2, T3 are direct to the logic central processor 12 through corresponding signal lines and from this are directed to the logic evaluation unit 13 and a further memory unit 14. Corresponding functional units F1 to Fn, not represented in greater detail, are actuated as a function of the temperature signal values T2, T3 measured in a suitable manner by the logic evaluation unit 13. The functional units F1 to Fn can, for example, be a radiator fan, an oil cooler, a flow restrictor for liquid coolant or also an indicator light for a driver of the motor vehicle.

If it is now established through the logic central processor 12 that one of the two temperature signals T2 or T3 is false within the framework of an established plausibility check (sensor defect) or no signal is delivered at all (sensor failure), then a temperature difference value Δt saved in the memory unit 11 is picked up by the logic central processor 12 which, like the subtraction unit 10, is connected to memory unit 11, and a substitution value for the defective or lacking temperature signal T2 or T3 is calculated with its assistance by means of subtraction or addition from or to the “correct” temperature signal T2 or T3. This substitute value is designated as a substitute value and is then forwarded together with the “correct” temperature signal T2 or T3 to the logic evaluation unit 13 for further processing (see above) and to the memory unit 14.

In the event of an error or failure of both temperature sensors S2, S3, the situation prior to the failure of the two sensors is “retained,” that is, the logic evaluation unit 12 falls back upon the temperature substitute values last saved in the memory unit 14, at least for a time period to be established. If the time span is exceeded, it can be provided that a functional component Fn is actuated such that a warning signal is conveyed to the driver to inform the driver of the failure of the control unit or the erroneousness sensor signal.

### REFERENCE NUMBERS

1 Control unit
10 Subtraction unit
11 Memory unit for temperature difference values
12 Logic central processing unit
13 Logic evaluating unit
14 Memory unit for temperature values
2 Motor control device
3 Motor oil
F1 . . . Fn Functional units
S2, S2 Temperature sensors
T2 Temperature signal generated by temperature sensor S2
T3 Temperature signal generated by temperature sensor S3
Δt1 . . . Δt18, Δtn Predefined temperature difference values
Δt1′ . . . Δt18′, Δtn′ Measured temperature difference values

1-6. (canceled)

7. A method of generating substitute values for measured values in either a control unit (1) or a regulating unit, whereby at least two measured values (T2, T3) are placed in a relationship to each other, the method comprising the steps of:
saving at least one value (Δt1, . . . ,Δt18) in a memory unit (11) of the control unit (1) which predefines a certain relationship between the at least two measured values (T2, T3);
measuring the measured values (T2, T3) during operation of the control unit (1), and the predefined relationship (Δt1, . . . ,Δt18) is overwritten by a relationship (Δt1′, . . . ,Δt18′) actually occurring during operation on the basis of the measurement in the memory unit (11),
calculating a substitute value for the measured values (T2, T3) to be measured by either a defective or a failed measuring apparatus (S2, S3) and transmitting the substitute value to the control unit (1) for further processing, after recognition of an error or a failure of the measuring apparatus (S2, S3) associated with the measured values (T2, T3) with the aid of the relationship (Δt1′, . . . ,Δt18′) actually occurring during operation on the basis of the measurement.

8. The method according to claim 7, further comprising the step of forming at least two measured values (T2, T3) of the same type and the relationship either predefined or actually arising during operation (Δt1, . . . ,Δt18 or Δt1′, . . . ,Δt18′) between the at least two measured values (T2, T3) by an estimated or actually measured differential amount (Δt1, . . . ,Δt18 or Δt1′, . . . ,Δt18′) of the values of the at least two measured values (T2, T3).

9. The method according to claim 7, further comprising the step of defining the at least two measured values (T2, T3) as temperatures.

10. Method according to claim 7, further comprising the step of defining the at least two measured values (T2, T3) as one of:
a temperature (T3) of motor oil located in a motor of a motor vehicle and a temperature (T2) of a motor control unit which is exposed to heat developed by a motor; and
a transmission oil temperature and a temperature of a transmission control unit which is exposed to heat developed by a transmission.

11. The method according to claim 7, further comprising the step of saving a plurality of either estimated or measured relationship values (Δt1, . . . ,Δt18; Δt1′, . . . ,Δt18′) in the memory unit (11) of the control unit (1).

12. The method according to claim 7, further comprising the step of utilizing the values, which were saved in the memory unit (14) of the control unit (1) prior to recognition of the error or the fault of the measuring apparatus, after recognizing errors of all measuring apparatuses (S2, S3) associated with at least two measured values.

13. A method of generating substitute values for two measured values (T2, T3) that are related, the method comprising the steps of:
saving at least one relationship value (Δt1, . . . ,Δt18) in a memory (11) of a control unit (1), with the relationship value (Δt1, . . . ,Δt18) predefining a certain relationship between the two measured values (T2, T3);
measuring the two measured values (T2, T3) with two measuring apparatus (S2, S3) during operation of the control unit (1);
calculating an actual relationship value (Δt1′,. . . ,Δt18′) which is based on the two measured values (T2, T3) and the predefined relationship value (Δt1, . . . ,Δt18);
overwriting the predefined relationship value (Δt1, . . . ,Δt18) with the actual relationship value (Δt1′, . . . ,Δt18′);
recognizing a failure of at least one of the two measuring apparatus (S2, S3) when the actual relationship value (Δt1′, . . . ,Δt18′) is outside a range of default relationship values; and
calculating substitute values for the measured values (T2, T3) and transmitting the substitute values to the control unit (1) for further processing.
